(19) United States
(12) Patent Application Publication
(10) Pub. No.: US 2026/0225203 A1
(43) Pub. Date: Aug. 6, 2026

(54) GRINDING BELT UNIT FOR DOUBLE-SIDED SHEET METAL PROCESSING

(71) Applicant: ARKU Maschinenbau GmbH, Baden-Baden (DE)

(72) Inventors: Jacques BURTSCHER, Rountzenheim-Auenheim (FR); Daniel Volz, Karlsruhe (DE)

(73) Assignee: ARKU Maschinenbau GmbH, Baden-Baden (DE)

(21) Appl. No.: 19/442,124

(22) Filed: Jan. 7, 2026

(30) Foreign Application Priority Data
Feb. 4, 2025 (EP) 25155797.4

(51) Int. Cl. B24B 21/14; B24B 21/20; B24B 49/00

(52) U.S. Cl. CPC B24B 21/14; B24B 21/20; B24B 49/00

(57) ABSTRACT

A grinding belt unit for a sheet metal processing machine with continuous operation, including: a grinding belt for grinding a workpiece passing through the sheet metal processing machine; a contact roller for contacting the grinding belt with the workpiece in a processing area and for deflecting the grinding belt, wherein a rotation axis of the contact roller is oriented substantially transversely to a pass-through direction of the workpiece; and two deflection rollers for deflecting the grinding belt outside the processing area, wherein rotation axes of the deflection rollers are oriented substantially transversely to the pass-through direction. Futher, a sheet metal processing machine.

The present invention relates to a grinding belt unit for a sheet metal processing machine with continuous operation as well as a sheet metal processing machine.

When cutting and punching parts from steel sheet, disturbing burrs form at the cut edges and the edges of holes and recesses, which protrude on the upper or lower side of the steel sheet. Particularly for parts that are made from steel sheet several centimeters thick, greater technical effort is required to deburr them, i.e., to round the edges and grind the surface.

EP 4 015 147 A1 discloses a machine for processing sheet metal parts. The machine comprises a machine frame, a conveyor belt for transporting the sheet metal part to be processed in the horizontal direction, and a plurality of processing units that are arranged one behind the other along the conveyor belt. The processing units comprise a brush unit with grinding brushes, a first grinding belt unit, and a second grinding belt unit. The grinding belt units are mounted in auxiliary frames, which are movable in the vertical direction relative to the machine frame. Adjustment devices are arranged between the machine frame and auxiliary frame. The brush unit is also mounted to be movable in the vertical direction, so that the different types of processing units are adjustable separately from one another to enable graduated processing of workpieces in one run.

So-called wide belt units enable efficient deburring. In these, endless grinding belts with a length of, for example, two or three meters are guided over deflection rollers. Depending on the width of the grinding belt, large-area sheet metal parts can also be ground or deburred. Longer endless grinding belts or endless wide belts have a longer service life. However, compared to shorter grinding belts, they often have the disadvantage that the corresponding structure of the grinding belt unit is more complex or more voluminous. In other words, longer grinding belts therefore require a larger installation space, particularly in a direction perpendicular to a pass-through plane of the workpieces. In addition, it is necessary that the grinding belt is kept under sufficient tension during operation and that oscillation of the grinding belt or running off of the grinding belt is prevented. Finally, ensuring a constant working height is necessary or advantageous to enable efficient loading and unloading of workpieces.

Due to these properties or specifications of grinding belt units, prior art sheet metal processing machines are equipped with only one or several grinding belt units for the upper side of the workpiece to be processed. The grinding belt unit is thus arranged in the upper part of the sheet metal processing machine and enables grinding of the upper side of the sheet metal part when passing through the sheet metal processing machine. Compared to double-sided processing of the sheet metal part from above and below, this often results in efficiency disadvantages, since the sheet metal processing machines often have to be passed through twice and the workpieces have to be turned. In a machine with multiple linked processing units, such as multiple grinding belt units and/or brush units with grinding brushes, this can lead to efficiency disadvantages.

Against this background, it is an object of the present invention to enable double-sided sheet metal processing by means of a grinding belt unit. In particular, a compactly constructed grinding belt unit is to be provided in which oscillation of the grinding belt is largely avoided and running off of the grinding belt is also counteracted. A sheet metal processing machine is to be provided which, compared to the prior art, enables more efficient processing of sheet metal parts and in particular efficient deburring in continuous operation. Finally, cost-efficient operation is to be enabled, also with regard to the use of relatively long endless grinding belts.

To solve this object, the present invention relates in a first aspect to a grinding belt unit for a sheet metal processing machine with continuous operation, comprising:
a grinding belt for grinding a workpiece passing through the sheet metal processing machine;
a contact roller for contacting the grinding belt with the workpiece in a processing area and for deflecting the grinding belt, wherein a rotation axis of the contact roller is oriented substantially transversely to a pass-through direction of the workpiece; and
two deflection rollers for deflecting the grinding belt outside the processing area, wherein rotation axes of the deflection rollers are oriented substantially transversely to the pass-through direction.

In a second aspect, the present invention relates to a grinding belt unit for a sheet metal processing machine with continuous operation, comprising:
a grinding belt for grinding a workpiece passing through the sheet metal processing machine;
a contact roller for contacting the grinding belt with the workpiece in a processing area and for deflecting the grinding belt, wherein a rotation axis of the contact roller is oriented substantially transversely to a pass-through direction of the workpiece;
a deflection roller for deflecting the grinding belt outside the processing area, wherein a rotation axis of the deflection roller is oriented substantially transversely to the pass-through direction;
a first and a second carrier, which are oriented substantially transversely to the pass-through direction, wherein the first carrier is connected on both sides to a bearing of the deflection roller at a fixed distance, the second carrier is connected on both sides to a bearing of the contact roller at a fixed distance, and a distance between the first and the second carrier is variable;
a tension unit for adjusting the distance between the first and the second carrier to adapt a tension of the grinding belt, wherein the tension unit comprises two actuators, which are each arranged in the region of ends of the two carriers, preferably each partially between the two carriers;
a rotation carrier, which is arranged between the second carrier and the contact roller and is rotatably connected to the second carrier about a central axis extending perpendicular to the pass-through direction; and
an oscillation unit for changing an angle between the second carrier and the rotation carrier to counteract oscillation and/or slipping off of the grinding belt.

In a further aspect, the present invention relates to a sheet metal processing machine, comprising:
a machine frame,
a conveying means for conveying workpieces through the sheet metal processing machine along the pass-through direction in a pass-through plane from a feed area to a discharge area; and
a grinding belt unit as described above mounted on the machine frame.

Preferred embodiments of the invention are described in the dependent claims. It is understood that the features mentioned above and those to be explained below can be used not only in the respectively indicated combination, but also in other combinations or alone, without departing from the scope of the present invention. In particular, the sheet metal processing machine can be designed accordingly to the embodiments described for the grinding belt unit in the dependent claims.

The grinding belt unit comprises a grinding belt, in particular an (exchangeable) endless wide belt. The grinding belt is guided over a contact roller, which is designed to contact the grinding belt with the workpiece. The workpiece (in particular sheet metal part) is guided past the contact roller and comes into contact with the grinding belt in the area of the contact roller. The grinding belt is deflected over the contact roller when in contact with the workpiece. The processing area corresponds to an area in the immediate vicinity of the contact roller in the radial direction of the contact roller toward a pass-through plane of the workpiece. The contact roller is oriented in particular transversely to the pass-through direction of the workpiece, so that all areas of the surface of the workpiece to be processed come into contact with the grinding belt. The orientation of the rotation axis can deviate slightly, for example in special applications in which special grinding patterns are to be generated, or to counteract oscillation or running off of the grinding belt.

The grinding belt is also deflected over the two deflection rollers, which are also arranged substantially transversely to the pass-through direction of the workpiece through the sheet metal processing machine and (substantially) parallel to the contact roller. The deflection rollers are positioned outside the processing area and thus, so to speak, on a side opposite the contact roller. The grinding belt is deflected on one side (on the side of contact with the workpiece) over the contact roller and on the other side over two deflection rollers.

Previous approaches for grinding belt units mostly provide for the use of only a single deflection roller. Compared to this, the structure according to the invention enables a more compact design of the grinding belt unit. Because the two deflection rollers can be arranged spaced apart from each other in the radial direction, deflection of a comparatively long endless wide belt can take place in a smaller installation space. Double-sided processing of workpieces (which are usually designed substantially flat) is enabled. A grinding belt unit can be arranged both above and below a pass-through plane of the workpieces. Because workpieces can be processed simultaneously from both sides or from above and below, an efficiency gain in processing can be achieved. In addition, more uniform processing can be achieved with less handling effort or manual effort for a machine operator.

According to the second aspect of the present invention, only a single deflection roller is provided, whose rotation axis is oriented substantially transversely to the pass-through direction. The grinding belt unit comprises a first carrier and a second carrier, which are also oriented substantially transversely to the pass-through direction. The first carrier is connected on both sides, i.e., in particular at both axial ends of the deflection roller, to a bearing of the deflection roller at a fixed distance. In addition, the second carrier is connected on both sides to a bearing of the contact roller at a fixed distance. The distance between the first carrier and the second carrier is variable. The distance here refers in particular to the distance perpendicular to the pass-through plane. By changing the distance perpendicular to the pass-through plane, an adjustment of the tension of the grinding belt can take place. This adjustment of the belt tension is carried out by means of a tension unit, which is designed to adjust the distance. The tension unit comprises two actuators, which are arranged in regions of ends of the two carriers. In particular, the actuators can be arranged between the first carrier and the second carrier. In addition, the grinding belt unit in the second embodiment comprises a rotation carrier between the second carrier and the contact roller. The rotation carrier is rotatably connected to the second carrier about a central axis extending perpendicular to the pass-through direction. Via an oscillation unit of the grinding belt unit, an angle between the first carrier and the rotation carrier can be changed to counteract oscillation and/or a slipping off of the grinding belt. In contrast to previous approaches, in which carriers for changing the distance perpendicular to the pass-through plane were each centrally connected via a single actuator, in the approach according to the invention two actuators are provided at ends of the carriers. This arrangement enables installation space savings. A minimum distance between the two carriers can be reduced. This enables the device according to the second aspect of the invention to have a space-saving structure of the grinding belt unit, particularly in a direction perpendicular to the pass-through plane.

The present invention enables use of wide belt technology also in machines with double-sided or bilateral processing. The unit according to the invention is smaller in a direction perpendicular to the pass-through plane and can thus also be arranged below the pass-through plane at usual working heights (heights of the pass-through plane above an installation surface of the machine). Particularly in height, the grinding belt unit is designed more compactly. This enables arrangement below the pass-through plane of the workpieces. Any existing specifications for working height can be maintained. Powerful double-sided processing of sheets or other workpieces is enabled.

In a preferred embodiment, the rotation axes of the two deflection rollers are arranged in a common plane running parallel to a pass-through plane of the workpiece. The common plane lies above or below the pass-through plane. By arranging the two deflection rollers in a common plane, a reduction in installation space is achieved, particularly with regard to the height of the unit. This results in efficiently implementable double-sided deburring by two grinding belt units arranged above or below a pass-through plane of the workpieces through the sheet metal processing machine. Efficient adjustment of the belt tension can be achieved. In particular, it is also possible to change a radial distance of the deflection rollers from each other to adjust a belt tension. It is also possible to arrange a carrier between the two deflection rollers in the common plane to thereby change a distance between the common plane and the contact roller to adjust the belt tension.

In a preferred embodiment, the grinding belt unit comprises a first carrier and a second carrier, which are oriented substantially transversely to the pass-through direction. The first carrier is connected on both sides to a bearing of the two deflection rollers at a fixed distance. The second carrier is connected on both sides to a bearing of the contact roller at a fixed distance perpendicular to the pass-through plane. A distance between the first carrier and the second carrier is variable. In addition, the grinding belt unit comprises a tension unit for adjusting the distance between the first carrier and the second carrier to adapt a tension of the grinding belt. By arranging the two carriers, a simple change of the distance between a plane of the deflection rollers and the contact roller can be enabled. This enables efficient adjustment of the belt tension. In particular, space-efficient adjustment of the belt tension can be enabled. Adjusting the distance via the tension unit can be done pneumatically or electromechanically. In particular, corresponding actuators can be provided to change the distance.

In a preferred embodiment, the two carriers are arranged in a plane extending perpendicular to the pass-through direction. The carriers thus enable adjustment of the belt tension by adjusting their distance from each other (in a direction perpendicular to the pass-through direction). This results in efficient constructability as well as a space-efficient possibility for adjusting the belt tension.

In a preferred embodiment, the tension unit comprises two actuators, which are each arranged in the region of ends of the two carriers, in particular two pneumatic cylinders. This results in efficient and compactly realizable adjustment of the belt tension. In addition, by using two independently controllable pneumatic cylinders, oscillations can also be counteracted or slipping off of the grinding belt can be prevented, if necessary using additional sensors. A space-efficient arrangement is enabled.

In a preferred embodiment, the grinding belt unit comprises a rotation carrier, which is arranged between the second carrier and the contact roller and is rotatably connected to the second carrier about a central axis extending perpendicular to the pass-through plane. In addition, the grinding belt unit comprises an oscillation unit for changing an angle between the second carrier and the rotation carrier. This can counteract oscillation and/or slipping off of the grinding belt. The rotatable central axis of the rotation carrier enables a change of an angle between the deflection roller on the one hand and the contact roller on the other hand. This in turn means that slipping off of the grinding belt can be prevented. By adjusting the angle, it can be achieved that the grinding belt does not slide or slip out of the processing area over the contact roller and/or over the deflection roller. The grinding belt is kept at as constant a position as possible with regard to guidance on the contact roller and deflection rollers. In particular, it can happen that due to tolerances or also due to processing of sheet metal parts, the grinding belt runs out of its position or out of its area on the contact roller and/or on the deflection roller or slides or slips out. In extreme cases, this can lead to damage to the processed workpiece or even the grinding belt unit or the sheet metal processing machine. The present structure with rotation carrier and oscillation unit enables space-efficient avoidance of oscillations and/or slipping grinding belt.

In a preferred embodiment, the oscillation unit comprises an actuator for adjusting the angular position, in particular a pneumatic cylinder. In addition, the oscillation unit comprises a first sensor for detecting a position of the grinding belt on the contact roller or on a deflection roller. The first sensor can in particular comprise a light barrier for detecting a binary signal indicative of a presence of the grinding belt in a detection area. The pneumatic cylinder or a central axis of the pneumatic cylinder can preferably be arranged in a plane running parallel to the pass-through plane of the workpieces. In this plane, pivoting of the second or third carrier relative to the respective other carrier can take place, so to speak. The angular position between the two carriers is changed by pivoting at least one carrier. The change in angular position causes the grinding belt to be influenced in its position on the rollers or the roller. By real-time detection of this position, control can thus be enabled. In particular, slipping off is detected or counteracted. It is advantageously sufficient to detect a presence of the grinding belt. As soon as the grinding belt is detected in the detection area, this means that counter-control is necessary. The counter-control is possibly achieved via corresponding control of the actuator. This results in an efficient structure in a small installation space.

In a preferred embodiment, the grinding belt unit comprises a further sensor for detecting whether the grinding belt leaves a safe area. In particular, a sensor with a light barrier can be used. In addition, the grinding belt unit comprises an emergency shutdown unit for shutting down belt operation of the grinding belt when it is detected that the grinding belt leaves the safe area. It is sufficient in particular to detect a presence of the grinding belt in an area that is only reached when a malfunction occurs. When this area is reached and the grinding belt has thus left the area of safe operation, an emergency shutdown can be triggered. This prevents damage to the workpiece, the grinding belt, and the sheet metal processing machine. The emergency shutdown unit thus further improves safety.

In a preferred embodiment, the grinding belt unit comprises a bearing of the deflection rollers, which is designed to adjust a relative orientation and/or a distance of the deflection rollers. In addition, the grinding belt unit comprises an alignment unit for adjusting the relative orientation and/or the distance of the deflection rollers to adjust a tension of the grinding belt and/or to counteract oscillation of the grinding belt. By changing the orientation of the deflection rollers relative to each other and/or the distance of the deflection rollers from each other, influence can be exerted on the grinding belt. In particular, a belt tension can be adjusted or oscillation of the grinding belt can be prevented or slipping off of the grinding belt from its operating position can be counteracted. Efficiently implementable provision of these functions is enabled. In addition, safe operation of the grinding belt unit or the sheet metal processing machine can be ensured.

In a preferred embodiment of the sheet metal processing machine, the sheet metal processing machine comprises a further grinding belt unit. The first grinding belt unit is arranged above the pass-through plane for grinding an upper side of the workpiece. The second grinding belt unit is arranged below the pass-through plane for grinding an underside of the workpiece. Double-sided sheet metal processing is enabled. In addition, comfortable operation is enabled since the working height can be kept comparatively low despite double-sided processing.

In a preferred embodiment of the sheet metal processing machine, it comprises an upper main frame, on which the first grinding belt unit is arranged, and a lower main frame, on which the second grinding belt unit is arranged. In addition, the sheet metal processing machine comprises an adjustment unit for adjusting a distance between the upper main frame and the lower main frame. The adjustment unit preferably comprises a lifting spindle gear. By using two main-frames, efficient adjustment of the distance between the upper grinding belt unit and the lower grinding belt unit can be enabled. The distance of the contact rollers of the two grinding belt units from each other in a direction perpendicular to the pass-through plane can be adjusted to allow processing of workpieces of different thicknesses. The adjustment can also be made automatically, for example based on corresponding sensors. The lower main frame or the lower unit can be fixed in its height above an installation surface of the machine. The adjustment with regard to the thickness of the workpieces can be made by adjusting the position of the upper main frame. A working height can be specified and fixed. Comfortable loading and unloading by a machine operator or also a correspondingly designed robot is enabled.

In a preferred embodiment, the sheet metal processing machine comprises one or more brush units for processing the workpiece with a brush tool. This results in efficient deburring of the workpiece.

The invention is described and explained in more detail below using some selected embodiment examples in connection with the accompanying drawings. They show:

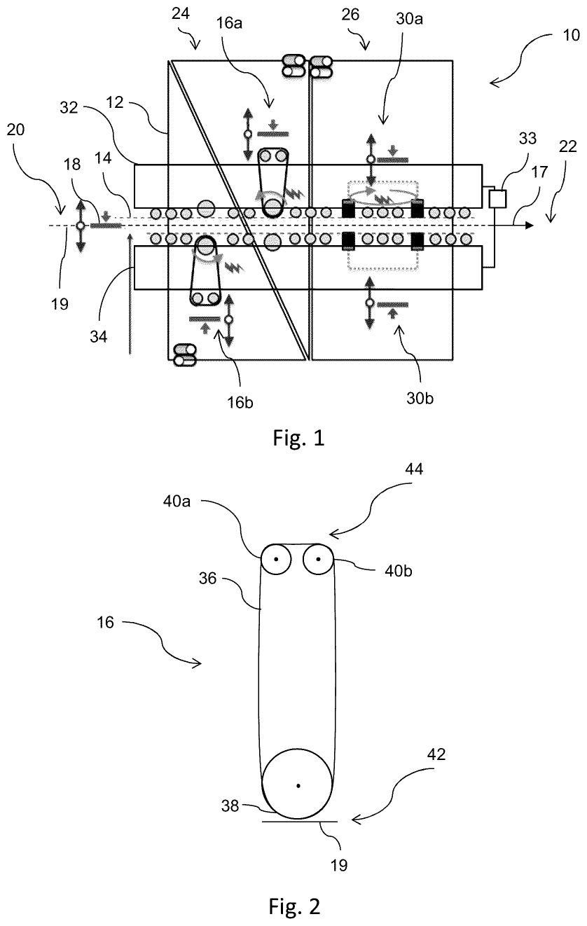

FIG. 1 a schematic representation of a sheet metal processing machine according to the present invention;

FIG. 2 a schematic representation of the structure of a grinding belt unit according to the invention;

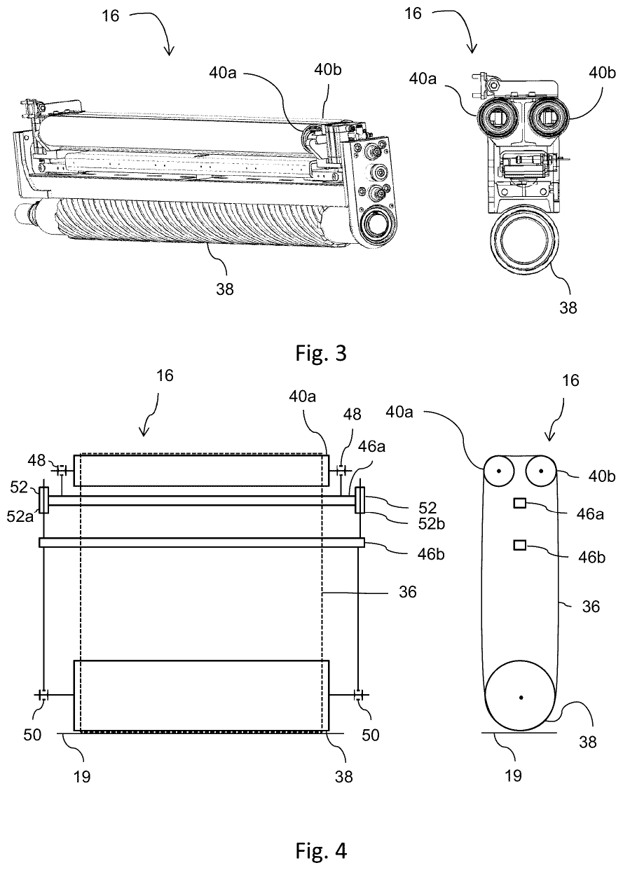

FIG. 3 two perspective views of a grinding belt unit according to the invention;

FIG. 4 a schematic representation of the structure of an embodiment of a grinding belt unit according to the invention;

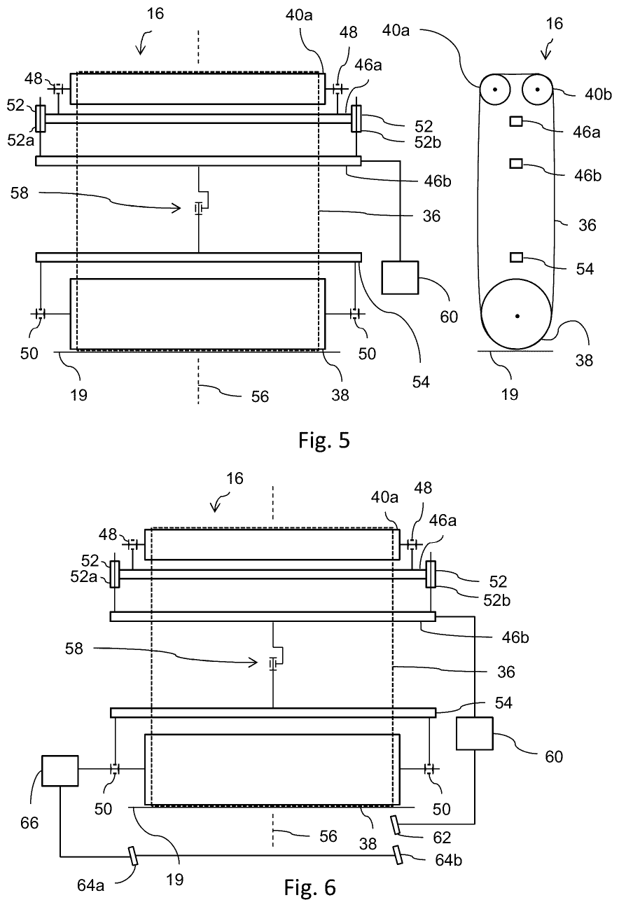

FIG. 5 a schematic representation of the structure of a further embodiment of a grinding belt unit according to the invention;

FIG. 6 a schematic representation of the use of sensors on a grinding belt unit according to the invention;

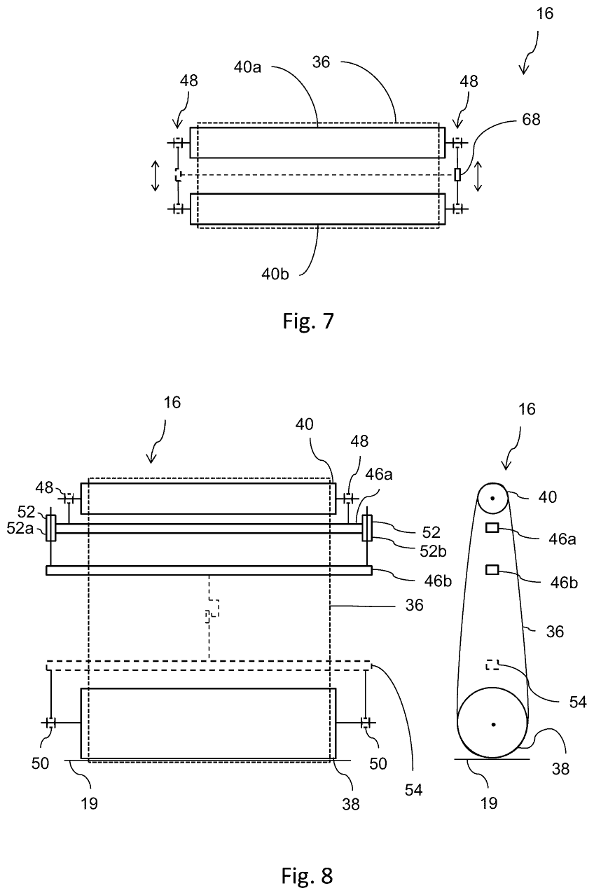

FIG. 7 a schematic representation of the function of an alignment unit for a grinding belt unit; and

FIG. 8 a schematic representation of the structure of a further embodiment of a grinding belt unit according to the invention.

In FIG. 1, a sheet metal processing machine 10 according to the invention is shown schematically. The sheet metal processing machine 10 comprises a machine frame 12, a conveying means 14, and two grinding belt units 16a, 16b mounted on the machine frame 12. The machine shown as an example enables processing of relatively thick sheet metal parts made from steel or stainless steel. For example, the sheet metal processing of the sheet metal processing machine 10 may be a deburring machine.

Workpieces 18 are conveyed by means of the conveying means 14, which may be designed as a conveyor belt, for example, along a pass-through direction 17 (from left to right in the illustration) from a feed area 20 to a discharge area 22. For example, a machine operator can place the workpieces 18 in the feed area 20 and another machine operator can pick up the workpieces 18 again in the discharge area 22. It is understood that automated handling of the workpieces 18 is also possible. The workpieces pass through the sheet metal processing machine 10 in a pass-through plane 19, which in the illustrated embodiment runs parallel to the floor or parallel to an installation surface of the machine.

The workpieces 18 pass through several processing stations during passage. In the illustrated embodiment, these processing stations comprise a grinding station 24 and a brush station 26. First, deburring takes place at the grinding station 24. Subsequently, rounding of the edges takes place at the brush station 26 to achieve clean surfaces.

In the grinding station 24, the workpieces 18 are ground from above and below. Grinding from above is performed by a first grinding belt unit 16a, grinding from below is performed by a second grinding belt unit 16b. The two grinding belt units 16a, 16b are arranged above and below the pass-through plane 19, respectively.

In the brush station 26, an upper brush unit 30a and a lower brush unit 30b are provided in a corresponding manner, which enable brushing processing of the workpieces 18 by means of several rotating grinding brushes. In particular, a so-called multi-rotation movement of grinding brushes can be used to achieve a clean surface of the workpieces 18.

In order to be able to process workpieces 18 of different thicknesses, an upper main frame 32 and a lower main frame 34 are provided in the illustrated embodiment, both of which are arranged on the machine frame 12. The first (upper) grinding belt unit 16a and the upper brush unit 30a are arranged on the upper main frame 32. The second (lower) grinding belt unit 16b and the lower brush unit 30b are arranged on the lower main frame 34. A distance between the upper main frame 32 and the lower main frame 34 can be changed by means of an adjustment unit 33.

In particular, it is advantageous if the upper main frame is flexibly attached to the machine frame 12 and is mounted to be movable, for example by means of pneumatic cylinders or lifting spindle drives, and the lower main frame 34 is essentially fixed or movable in its height relative to the machine frame 12 only within narrow limits. This enables provision of a fixed working height.

In FIG. 2, the structure of a grinding belt unit 16 according to the invention is shown. The illustration is to be understood as a lateral sectional view. The grinding belt unit 16 comprises a grinding belt 36, a contact roller 38, and two deflection rollers 40a, 40b. In particular, the use of two deflection rollers 40a, 40b results in a comparatively compact structure compared to a conventional structure with only one deflection roller. A minimum height of the unit or a minimum distance between a processing area 42, where the grinding belt 36 comes into contact with the workpiece, and a deflection area 44, in which the workpiece is deflected by means of the deflection rollers 40a, 40b, is reduced. In the processing area 42, the grinding belt 36 is guided over the contact roller 38. In this process, contact is established between the grinding belt 36 and the workpiece 18 in the processing area 42 and the workpiece 18 is ground.

In the illustrated embodiment in FIG. 2, in conjunction with FIG. 1, it can be seen that the rotation axes of the deflection rollers 40a, 40b are arranged in a common plane running parallel to the pass-through plane 19 of the workpiece 18. This common plane of the deflection rollers 40a, 40b can lie above or below the pass-through plane 19 of the workpieces 18, depending on whether the grinding belt unit 16 is arranged above or below the pass-through plane and grinding of the workpiece 18 takes place from above or below.

In FIG. 3, an embodiment of a grinding belt unit 16 according to the invention is shown in two perspective views. On the left side, an oblique view is chosen. On the right side, an axial view in the direction of rotation axes of the contact roller 38 and the deflection rollers 40a, 40b is shown. In both views, the grinding belt is hidden to enable a clear representation. Usually, a rotation axis of the contact roller 38 and rotation axes of the deflection rollers 40a, 40b are aligned transversely to the pass-through direction of the workpiece 18 during operation of the grinding belt unit 16 in the sheet metal processing machine 10. However, slight deviations in the sense of an inclination of the contact roller 38 and the deflection rollers 40a, 40b relative to the pass-through direction are possible, for example to generate a special grinding pattern.

In FIG. 4, an embodiment of the grinding belt unit 16 is shown schematically. In particular, FIG. 4 shows on the left side a frontal view or a frontal section in a plane perpendicular to the pass-through plane and on the right side a lateral view or an axial section with respect to the rotation axes of the contact roller 38 and the deflection rollers 40a, 40b.

In the illustrated embodiment, the grinding belt unit 16 comprises a first carrier 46a and a second carrier 46b. The first carrier 46a is connected on both sides to a bearing 48 of the two deflection rollers 40a, 40b at a fixed distance perpendicular to the pass-through plane 19. On both sides of the deflection rollers 40a, 40b, a fixed connection is provided between the first carrier 46a and the bearing 48 of the deflection rollers 40a, 40b. The second carrier 46b is connected to a bearing 50 of the contact roller 38. It can be seen in particular that the two carriers 46a, 46b are arranged in a plane running essentially perpendicular to the pass-through direction. By changing the distance between the two carriers 46a, 46b, a distance between the contact roller 38 and the deflection rollers 40a, 40b is changed. The adjustment or change of this distance enables adaptation of the tension of the grinding belt 36. The endless grinding belt is, so to speak, clamped in the grinding belt unit 16 by a corresponding change in the distance between the first carrier 46a and the second carrier 46b.

A tension unit 52 is provided for changing the distance between the first carrier 46a and the second carrier 46b. In the illustrated embodiment, the tension unit 52 comprises two actuators 52a, 52b, which are each arranged in the region of ends of the two carriers 46a, 46b. The two actuators 52a, 52b can in particular be designed as pneumatic cylinders and/or be arranged partially between the carriers. The actuators 52a, 52b thus act on the ends of the two carriers to change the distance between the carriers. The two actuators 52a, 52b are preferably controlled together to maintain parallelism between the two carriers 46a, 46b even when changing the distance.

In FIG. 5, a further embodiment of a grinding belt unit 16 according to the invention is shown. As before, the left side shows a schematic representation or a sectional view with respect to the pass-through direction and the right side shows a lateral view or sectional view transverse to the pass-through direction.

The embodiment shown in FIG. 5 also comprises two carriers 46a, 46b. In addition, a rotation carrier 54 is provided, which is arranged perpendicular to the pass-through plane 19 between the second carrier 46b and the contact roller 38. The rotation carrier 54 is arranged between the contact roller 38 and the second carrier 46b, starting from the pass-through plane 19. The rotation carrier 54 is rotatably connected to the second carrier 46b about a central axis 56 running perpendicular to the pass-through plane 19. In the illustrated embodiment, the rotatability results from a corresponding rotary joint 58 between the rotation carrier 54 and the second carrier 46b.

Also in the representation in FIG. 5, as before, the distance of the second carrier 46b from the bearing 50 of the contact roller perpendicular to the pass-through plane 19 is constant. In other words, the rotary joint 58 or the rotatability between the second carrier 46b and the rotation carrier 54 does not affect the distance between the second carrier 46b and the rotation carrier 54 in the direction perpendicular to the pass-through plane 19.

By means of an oscillation unit 60, an angle between the second carrier 46b and the rotation carrier 54 can be changed. The change of this angle corresponds to a change in the angle between the contact roller 38 and the deflection rollers 40a, 40b. A (minimal) change in the angle can counteract slipping off or sliding off of the grinding belt 36. It can thus be ensured that the grinding belt 36 is guided over the contact roller 38 and does not run out in the axial direction. Such running off or sliding off of the grinding belt 36 can occur, for example, due to material fatigue, different loading, inaccurately positioned workpieces, or other effects. For example, it can be provided that slipping off is detected and corresponding control of the oscillation unit 60 takes place to counteract the slipping off. The oscillation unit 60 can in particular comprise a pneumatic cylinder that exerts a force on the rotation carrier 54 and is arranged, for example, in an end region of the rotation carrier 54. The angular position between the contact roller 38 and the deflection rollers 40a, 40b is slightly changed by the oscillation unit 60. In this respect, the rotation axes are then no longer necessarily completely parallel, but deviate slightly from each other in their orientation.

In FIG. 6, an embodiment is shown in which a first sensor 62 is provided for detecting a position of the grinding belt 36 on the contact roller 38. In particular, this first sensor 62 can comprise a light barrier or a light sensor that outputs a binary signal as to whether the grinding belt 36 is in a detection area or not. When the grinding belt 36 reaches the detection area, control of the oscillation unit 60 can take place to make a corresponding adjustment of the angular position between the contact roller 38 and the deflection rollers 40a, 40b. This adjustment can counteract the slipping off of the grinding belt 36. The adjustment usually takes place by fractions of a degree, so that there are only slight deviations in the parallelism between the rotation axes of the contact roller 38 and the deflection rollers 40a, 40b.

In the illustrated embodiment in FIG. 6, two further sensors 64a, 64b are also provided. These further sensors 64a, 64b detect whether the grinding belt 36 leaves a safe area. The further sensors 64a, 64b can comprise a light barrier or a light sensor. When the safe area is left or an area is reached in which safe operation of the grinding belt unit 16 can no longer be guaranteed, an emergency shutdown of the grinding belt unit 16 is triggered via an emergency shutdown unit 66. The emergency shutdown unit 66 can in particular act on a main drive (not shown). In this respect, for example, if counter-control can no longer take place by the first sensor 62 or the oscillation unit 60 or sufficiently fast counter-control has not taken place, it can still be ensured that damage to the machine or the unit is avoided.

In FIG. 7, a further embodiment of the grinding belt unit 16 according to the invention is shown as a schematic top view in the region of the deflection rollers 40a, 40b. The view is chosen in particular parallel to the pass-through plane. It is possible that a bearing 48 of the deflection rollers is designed to adjust a relative orientation and/or a distance of the deflection rollers 40a, 40b. In particular, the bearing 48 can comprise an alignment unit 68, by which a tension of the grinding belt 36 can be adjusted and/or oscillation of the grinding belt 36 can be counteracted. In particular, it is possible that the alignment unit 68 comprises one or two pneumatic cylinders. It is sufficient to arrange a pneumatic cylinder on one of the two sides of the deflection rollers 40a, 40b and to keep the distance between the axial bearing points on the other side of the deflection rollers 40a, 40b constant. Of course, actuators arranged on both sides are also possible. The use of a bearing 48 of the deflection rollers 40a, 40b, which is designed by means of an alignment unit 68 to adjust a relative orientation and/or a distance of the deflection rollers 40a, 40b, enables a further option for adjusting the tension of the grinding belt 36 or for counteracting oscillations of the grinding belt 36.

In FIG. 8, an embodiment of the grinding belt unit 16 is shown in which only a single deflection roller 40, but two carriers 46a, 46b are provided. The first carrier 46a is connected on both sides to the bearing 48 of the deflection roller. The second carrier 46b is connected on both sides to the bearing 50 of the contact roller at a fixed distance perpendicular to the pass-through plane 19. In the illustrated embodiment, an (optional) rotation carrier 54 is additionally shown in dashed lines. The tension unit 52 comprises two actuators 52a, 52b, which are each arranged in the region of ends of the two carriers 46a, 46b. Preferably, pneumatic cylinders can be used. Also in connection with a single deflection roller 40, the actuators 52a, 52b result in space savings perpendicular to the pass-through plane 19. Installation space can be saved. This enables use of a grinding belt unit 16 according to the invention for double-sided processing of a workpiece 18 in a sheet metal processing machine 10.

In the figures described above, the same reference numerals designate the same units or components. For better representation, repetition is omitted where appropriate. It is understood that the representations are not to scale and are to be understood essentially qualitatively. In particular, in individual representations, components of the grinding belt unit or the sheet metal processing machine are hidden to enable visualization of individual or relevant components.

The invention has been comprehensively described and explained with reference to the drawings and the description. The description and explanation are to be understood as examples and not as limiting. The invention is not limited to the disclosed embodiments. Other embodiments or variations will become apparent to those skilled in the art when using the present invention and upon careful analysis of the drawings, the disclosure, and the following claims.

In the claims, the words “comprise” and “with” do not exclude the presence of other elements or steps. The indefinite article “a” or “an” does not exclude the presence of a plurality. A single element or a single unit can perform the functions of several of the units mentioned in the claims. The mere mention of some measures in several different dependent claims is not to be understood as meaning that a combination of these measures cannot also be used advantageously. Reference signs in the claims are not to be construed as limiting.

### REFERENCE NUMERALS

10 Sheet metal processing machine
12 Machine frame
14 Conveying means
16 Grinding belt unit
16a First grinding belt unit
16b Second grinding belt unit
17 Pass-through direction
18 Workpiece
19 Pass-through plane
20 Feed area
22 Discharge area
24 Grinding station
26 Brush station
30a Upper brush unit
30b Lower brush unit
32 Upper main frame
33 Adjustment unit
34 Lower main frame
36 Grinding belt
38 Contact roller
40, 40a, 40b Deflection rollers
42 Processing area
44 Deflection area
46a First carrier
46b Second carrier
48 Bearing of the deflection rollers
50 Bearing of the contact roller
52 Tension unit
52a, 52b Actuators
54 Rotation carrier
56 Central axis
58 Rotary joint
60 Oscillation unit
62 First sensor
64a, 64b Further sensor
66 Emergency shutdown unit
68 Alignment unit

1. A grinding belt unit for a sheet metal processing machine with continuous operation, comprising:
a grinding belt for grinding a workpiece passing through the sheet metal processing machine;
a contact roller for contacting the grinding belt with the workpiece in a processing area and for deflecting the grinding belt, wherein a rotation axis of the contact roller is oriented substantially transversely to a pass-through direction of the workpiece; and
two deflection rollers for deflecting the grinding belt outside the processing area, wherein rotation axes of the deflection rollers are oriented substantially transversely to the pass-through direction.

2. The grinding belt unit according to claim 1, wherein the rotation axes of the two deflection rollers are arranged in a common plane running parallel to a pass-through plane of the workpiece, which lies above or below the pass-through plane.

3. The grinding belt unit according to claim 1, comprising
a first carrier and a second carrier, which are oriented substantially transversely to the pass-through direction, wherein the first carrier is connected on both sides to a bearing of the two deflection rollers at a fixed distance, the second carrier is connected on both sides to a bearing of the contact roller at a fixed distance perpendicular to the pass-through plane and a distance between the first and the second carrier is variable; and
a tension unit for adjusting the distance between the first and the second carrier to adapt a tension of the grinding belt.

4. The grinding belt unit according to claim 3, wherein the two carriers are arranged in a plane extending substantially perpendicular to the pass-through direction.

5. The grinding belt unit according to claim 3, wherein the tension unit comprises two actuators, which are each arranged in the region of ends of the two carriers.

6. The grinding belt unit according to claim 4, comprising
a rotation carrier, which is arranged between the second carrier and the contact roller and is rotatably connected to the second carrier about a central axis extending perpendicular to the pass-through plane; and
an oscillation unit for changing an angle between the second carrier and the rotation carrier to counteract oscillation and/or slipping off of the grinding belt.

7. The grinding belt unit according to claim 6, wherein the oscillation unit.
comprises an actuator for adjusting the angular position, and
comprises a first sensor for detecting a position of the grinding belt on the contact roller or on a deflection roller.

8. The grinding belt unit according to claim 1, comprising
a further sensor for detecting whether the grinding belt leaves a safe area; and
an emergency shutdown unit for shutting down a belt drive of the grinding belt when it is detected that the grinding belt leaves the safe area.

9. The grinding belt unit according to claim 1, comprising
a bearing of the deflection rollers, which is designed to adjust a relative orientation and/or a distance of the deflection rollers from each other; and
an alignment unit for adjusting the relative orientation and/or the distance of the deflection rollers from each other to adjust a tension of the grinding belt and/or to counteract oscillation of the grinding belt.

10. A grinding belt unit for a sheet metal processing machine with continuous operation, comprising:
a grinding belt for grinding a workpiece passing through the sheet metal processing machine;
a contact roller for contacting the grinding belt with the workpiece in a processing area and for deflecting the grinding belt, wherein a rotation axis of the contact roller is oriented substantially transversely to a pass-through direction of the workpiece;
a deflection roller for deflecting the grinding belt outside the processing area, wherein a rotation axis of the deflection roller is oriented substantially transversely to the pass-through direction;
a first carrier and a second carrier, which are oriented substantially transversely to the pass-through direction, wherein the first carrier is connected on both sides to a bearing of the deflection roller at a fixed distance, the second carrier is connected on both sides to a bearing of the contact roller at a fixed distance and a distance between the first and the second carrier is variable;
a tension unit for adjusting the distance between the first and the second carrier to adapt a tension of the grinding belt, wherein the tension unit comprises two actuators, which are each arranged in the region of ends of the two carriers;
a rotation carrier, which is arranged between the second carrier and the contact roller and is rotatably connected to the second carrier about a central axis extending perpendicular to the pass-through direction; and
an oscillation unit for changing an angle between the second carrier and the rotation carrier to counteract oscillation and/or slipping off of the grinding belt.

11. A sheet metal processing machine comprising
a machine frame;
a conveying means for conveying workpieces through the sheet metal processing machine along the pass-through direction in a pass-through plane from a feed area to a discharge area; and
a grinding belt unit according to claim 1 mounted on the machine frame.

12. The sheet metal processing machine according to claim 11, comprising
a further grinding belt unit, wherein
a first grinding belt unit for grinding an upper side of the workpiece is arranged above the pass-through plane and a second grinding belt unit for grinding an underside of the workpiece is arranged below the pass-through plane.

13. The sheet metal processing machine according to claim 12, comprising
an upper main frame, on which the first grinding belt unit is arranged; and a lower main frame, on which the second grinding belt unit is arranged; and
an adjustment unit for adjusting a distance between the upper main frame and the lower main frame.

14. The sheet metal processing machine according to claim 13, wherein the adjustment unit comprises a lifting spindle gear.

15. The sheet metal processing machine according claim 11, comprising one or several brush units for processing the workpiece with a brush tool.

16. The grinding belt unit according to claim 5, wherein the two actuators are two pneumatic cylinders and/or the two actuators are arranged partially between the two carriers.

17. The grinding belt unit according to claim 7, wherein the oscillation unit comprises a pneumatic cylinder.

18. The grinding belt unit according to claim 7, wherein the oscillation unit comprises a first sensor with a light barrier for detecting a binary signal indicative of a presence of the grinding belt in a detection area.

19. The grinding belt unit according to claim 8, comprising a further sensor with a light barrier.

20. The grinding belt unit according to claim 10, wherein the two actuators of the tension unit are each arranged partially between the two carriers.
